(19) United States
(12) Patent Application Publication
(10) Pub. No.: US 2005/0113514 A1
(43) Pub. Date: May 26, 2005

(54) 4-N-acyl-delta 5-2-oxopiperazines, a process for its preparation and combinatorial libraries thereof

(76) Inventors: Jie Fei Cheng, Carlsbad, CA (US); Mi Chen, San Diego, CA (US); Alex M. Nadzan, Encinitas, CA (US)

Correspondence Address: Daniel W Collins;Chugai Pharma USA, 6275 Nancy Ridge Drive, San Diego, CA, 92121, US

(21) Appl. No.: 10/362,698

(22) PCT Filed: Aug. 22, 2001
(86) PCT No.: PCT/US01/26382

Related U.S. Application Data
(60) Provisional application No. 60/228,701, filed on Aug. 29, 2000.

(51) Int. Cl. C08G 63/91

(52) U.S. Cl. 525/54.1

(57) ABSTRACT

A novel solution phase and solid phase synthesis of 4-N-acyl-Δ⁵-2-oxopiperazine (I) is described via a Ugi four-component condensation of an acid, an ketone or aldehyde, a protected α-aminoaldehyde or α-aminoketone and an isocyanide followed by an N-acyliminium ion cyclization facilitated by an acid, which also cleaves the product from the polymer when the reaction is conducted in the solid phase.

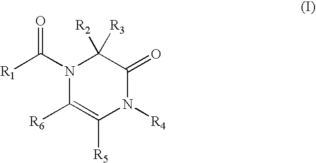

### FIELD OF THE INVENTION

This invention relates to a process for preparing a novel Δ⁵-2-oxopiperazine compound, novel Δ⁵-2-oxopiperazine compounds, and a novel combinatorial library of Δ⁵-2-oxopiperazine compounds.

### BACKGROUND

2-Oxopiperazines are important pharmacophores that have been reported in a number of marketed drugs or drug candidates under development. Examples include enkephalin analogues which contain 5,6-unsubstituted 2-oxopiperazines (Piercy, M. F. et al., Brain Res. 74, 385 (1986), glycoprotein IIb/IIIa angtagonists (Takada, S. et al.; Pharm. Res. 14, 1146 (1997); Sugihara, H. et al., J. Med. Chem. 41, 489(1998)) and substance P antagonist (Wright, et al., J. Med. Chem. 11, 390 (1968)). Antihelminthic drug Praziquantel contains a 2-oxopiperazine moiety that is fused to an aromatic ring. On the other hand, 2-oxopiperazine moiety can also be used as a β-turn mimics of a dipeptide and has been incorporated into a cyclic peptide as potential active site mimic of lipase (Uchida et al., Chem. Pharm. Bull. 45, 1228 (1997)).

The formation of 2-oxopiperazine ring structure has been an important field of study. However, few methods have been established for the synthesis of these kinds of compounds. Lengthy synthesis of 5,6-unsaturated 2-oxopiperazine starting from protected aminoacids has been reported (Bohlman et al., J. Org. Chem. 62, 1016(1997), Bhatt et al., Tetrahedron Lett. 38, 3679 (1997)). No general synthesis of Δ⁵-2-oxopiperazines has been described in the literature.

The discovery of new pharmaceutically active compounds for a given indication involves the screening of all compounds from available compound collections. The combinatorial synthesis, or parallel synthesis, of large arrays of single compounds is now an important component of modern drug discovery process. The multiple component condensation (MCC) reactions are particularly attractive for rapid access to large numbers of structural analogs in a single step. There has thus been recent interest in the application of the Ugi (Ugi, I., Angew. Chem. Int. Ed. Engl. 1, 8 (1962)), Passerini, Biginelli, and other multiple component condensations to the solid phase thereby simplifying work up and enabling reactions to be driven to completion by using reagent excesses subsequently removed by filtration.

### SUMMARY OF THE INVENTION

The object of this invention is to develop novel solution phase and solid phase methodologies to synthesize pharmaceutically important Δ⁵-2-oxopiperazine compounds.

In one aspect, this invention provides a process for preparing a Δ⁵-2-oxopiperazine compound of the formula 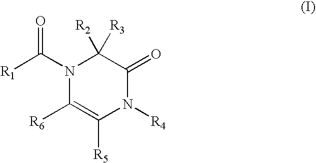
comprising the steps of:
(i) reacting the following four compounds:
a carboxylic acid compound of formula
   R₁COOH,
a ketone or aldehyde compound of formula
   R₂COR₃,
an isocyanide compound of formula
   R₄NC, and
a protected α-aminoaldehyde or α-aminoketone compound of formula R₅CH(NH₂)C(OP)₂R₆, wherein P is a protecting group of the carbonyl group in a solvent to produce an intermediate compound of the formula (VI), 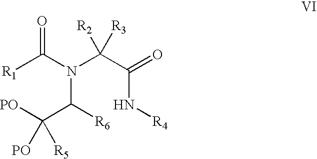
   , and
ii) reacting the intermediate compound under acidic condition to provide the Δ⁵-2-oxopiperazine compound,
wherein R₁ is a substituent derived from a carboxylic acid of formula R₁COOH,
R₂ and R₃ represent hydrogen, or an organic moiety derived from a ketone or an aldehyde of the formula R₂COR₃,
R₄ is an organic moiety derived from an isocyanide of formula R₄NC which in turn is derived from a primary amine of the formula R₄NH₂,
R₅ and R₆ are organic moieties derived from a protected α-aminoaldehyde or α-aminoketone of the formula R₅CH(NH₂)C(OP)₂R₆, wherein P is a protecting group of the carbonyl group.

Preferably, R₁ represents aromatic, aliphatic, heterocyclic, or heteroaryl groups, R₂ represents aliphatic, aromatic, heterocyclic, or heteroayl groups, R₃ represents hydrogen, R₄ represents aliphatic, aromatic, heterocyclic, or heteroaryl groups, R₅ represents hydrogen, and R₆ represents hydrogen.

Preferably, the reaction is conducted in the solution phase. All the said four compounds are dissolved in a solvent and the resulting intermediate is treated with an acid to yield the desired product.

Preferably, the reaction is conducted in the solid phase. One of said four compounds is linked to a solid support via an acid labile linkage before it is used to react with other three compounds in a Ugi four component condensation type reaction. More preferably, said isocyanide compound of formula R₄NC is linked to a solid support. The intermediate formed is linked to a solid support, which upon treatment with an acid affords the desired compound of formula (I). Preferably, said acid is trifluoroacetic acid (TFA).

In another aspect, this invention provides a compound of formula (I) 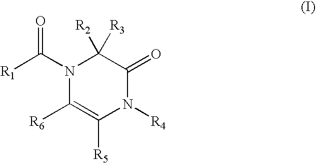
wherein R₁ is a substituent derived from a carboxylic acid of formula R₁COOH,
R₂ and R₃ represent hydrogen, or an organic moiety derived from a ketone or an aldehyde of the formula R₂COR₃,
R₄ is an organic moiety derived from an isocyanide of formula R₄NC which in turn is derived from a primary amine of the formula R₄NH₂,
R₅ and R₆ are organic moieties derived from a protected α-aminoaldehyde or α-aminoketone of the formula R₅CH(NH₂)C(OP)₂R₆, wherein P is a protecting group of the carbonyl group. Preferably, R₁ represents aliphatic, aromatic, heterocyclic, or heteroaryl groups, R₂ represents aliphatic, aromatic, heterocyclic, or heteroaryl groups, R₃ represents hydrogen, R₄ represents aliphatic, aromatic, heterocyclic, or heteroaryl groups, R₅ represents hydrogen, and R₆ represents hydrogen.

In a still further aspect, this invention provides a combinatorial library of Δ⁵-2-oxopiperazine compounds wherein said library contains a plurality of diverse library compounds of the formula (I) 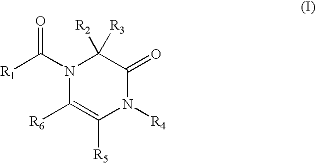
wherein R₁ is a substituent derived from a carboxylic acid of formula RICOOH,
R₂ and R₃ represent hydrogen, or an organic moiety derived from a ketone or an aldehyde of the formula R₂COR₃,
R₄ is an organic moiety derived from an isocyanide of formula R₄NC which in turn is derived from a primary amine of the formula R₄NH₂,
R₅ and R₆ are organic moieties derived from a protected α-aminoaldehyde or α-aminoketone of the formula R₅CH(NH₂)C(OP)₂R₆, wherein P is a protecting group of the carbonyl group. Preferably, R₁ represents aliphatic, aromatic, heterocyclic, or heteroaryl groups, R₂ represents aliphatic, aromatic, heterocyclic, or heteroaryl groups, R₃ represents hydrogen, R₄ represents aliphatic, aromatic, heterocyclic, or heteroaryl groups, R₅ represents hydrogen, and R₆ represents hydrogen.

### DETAILED DESCRIPTION OF THE INVENTION

The detailed description of the invention which follows is not intended to be exhaustive or to limit the invention to the precise details disclosed. It has been chosen and described to best explain the details of the invention to others skilled in the art.

Without being limited by the theory, it is thought that the process of this invention provides novel Δ⁵-2-oxopiperazine compounds and a combinatorial library of Δ⁵-2-oxopiperazine compounds, and the novel Δ⁵-2-oxopiperazine compounds are useful as pharmaceutical agents.

The process for preparing a Δ⁵-2-oxopiperazine compound of this invention comprises the steps of
(i) reacting substantially the following four compounds:
a carboxylic acid compound of formula
   R₁COOH,
a ketone or aldehyde compound of formula
   R₂COR₃,
an isocyanide compound of formula
   R₄NC, and
a protected α-aminoaldehyde or α-aminoketone compound of formula R₅CH(NH₂)C(OP)₂R₆, wherein P is a protecting group of the carbonyl group,
in a solvent to produce an intermediate compound of the formula (VI) 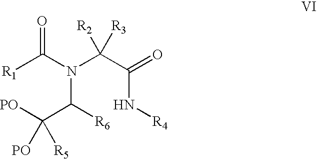
   , and
ii) reacting the intermediate compound under acidic condition to provide the Δ⁵-2-oxopiperazine compound.

The reacting steps involve in either solution phase or solid phase as described in Scheme 1 to 6. The first reacting step, that is the mixing of all four compounds mentioned above in a solvent, yields an intermediate compound of formula (VI), which is treated with an acid to produce the targeted compound Δ⁵-2-oxopiperazines after the conventional purification procedure.

In the solution phase synthesis, the said four reactants are dissolved in a solvent to form an intermediate, which is converted into the desired product under acidic condition. Preferred solvent and acid in the solution phase synthesis are methanol and hydrochloric acid, respectively. The organic solvents in the reaction mixture are removed in vacuo and the residue is purified to give the desired product.

In the solid phase synthesis, one of said four compounds is connected to a solid support before it is used in the first reacting step. The intermediate compound formed following Ugi four component condensations is bounded to the solid support via an acid labile linkage, which is washed with known organic solvents and dried under vacuum. Under acidic condition, the intermediate bounded to the solid support undergoes cyclization. Meanwhile, the product is cleaved from the solid support under this condition. Trifluoroacetic acid (TFA) is a preferable acid to facilitate the cyclization as well as the cleavage. After removal of the solvent and the acid, the product is obtained in pure form directly or following a conventional purification procedure.

Compounds of this invention are generally represented by the following general structure (I): 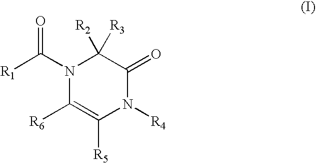
wherein R₁ is a substituent derived from a carboxylic acid of formula R₁COOH,
R₂ and R₃ represent hydrogen, or an organic moiety derived from a ketone or an aldehyde of the formula R₂COR₃,
R₄ is an organic moiety derived from an isocyanide of formula R₄NC which in turn is derived from a primary amine of the formula R₄NH₂,
R₅ and R₆ are organic moieties derived from a protected α-aminoaldehyde or α-aminoketone of the formula R₅CH(NH₂)C(OP)₂R₆, wherein P is a protecting group of the carbonyl group.

More preferred compounds of this invention are generally represented by the following general structure (I-A): 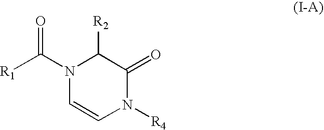
Wherein R₁ represents aliphatic, aromatic, heterocyclic, or heteroaryl groups,
R₂ represents aliphatic, aromatic, heterocyclic, or heteroaryl groups,
R₄ represents aliphatic, aromatic, heterocyclic, or heteroaryl groups.
Definitions

Where nomenclature is simple, for the purpose of nomenclature the numbering follows the IUPAC convention. For illustration purposes, the parent Δ⁵-2-oxopiperazine or Δ⁵-2-ketopiperazine ring structure is IUPAC numbered as follows:

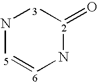

As used above, and throughout the description of the invention, the following terms, unless otherwise indicated, shall be understood to have the following meanings.

“Acid labile carbonyl protecting group”, as used herein, means an carbonyl protecting group which is readily removed by treatment with an acid while remaining relatively stable to other reagents. Preferred acid labile carbonyl protecting group in the invention is diethyl acetal.

“Acid labile linkage”, as used herein, means the link between an organic molecule and a solid support (or resin) can be removed or cleaved by treatment with an acid while remaining stable to other reagents. Examples of acid labile linkage include ether or ester bond on Wang resin, amide bond on Rink resin. Preferred acids to cleave the product from these resins are trifluoroacetic acid or HF.

“Acyl”, as used herein, means an H—CO— or alkyl-CO—, aryl-CO—, heteroaryl-CO, cycloalkyl-CO, heterocycloalkyl-CO— groups wherein alkyl, aryl, heteroaryl, cycloalkyl, heterocycloalkyl groups are as herein described.

“Alkyl”, as used herein, means straight or branched chain or cyclic hydrocarbon having 1 to 20 carbon atoms.

“Aliphatic”, as used herein, means a radical derived from a non aromatic C—H bond by removal of the hydrogen atom. The aliphatic radical may be further substituted by additional aliphatic or aromatic radicals as defined herein. Representative aliphatic groups include alkyl, alkenyl, alkynyl, cycloalkyl, cycloalkenyl, heterocyclyl, heterocyclenyl, aralkenyl, aralkyloxyalkyl, aralkyloxycarbonylalkyl, aralkyl, aralkynyl, aralkyloxyalkenyl, heteroaralkenyl, heteroaralkyl, heteroaralkyloxyalkenyl, heteroaralkyloxyalkyl, heteroaralkynyl, fused arylcycloalkyl, fused heteroarylcycloalkyl, fused arylcycloalkenyl, fused heteroarylcycloalkenyl, fused arylheterocyclyt, fused heteroarylheterocyclyl, fused aryiheterocyclenyl, fused heteroarylheterocyclenyl, and the like as described herein, which are optionally substituted including to a solid support (or resin) directly or through a linker attached to the to the solid support.

“Aromatic”, as used herein, means a radical derived from an aromatic C—H bond by removal of the hydrogen. Aromatic includes both aryl and heteroaryl rings as defined herein. The aryl or heteroaryl ring may be further substituted by additional aliphatic or aromatic radicals as defined herein. Representative aromatic groups include aryl, fused cycloalkenylaryl, fused cycloalkylaryl, fused heterocyclylaryl, fused heterocyclenylaryl, heteroaryl, fused cycloalkylheteroaryl, fused cycloalkenylheteroaryl, fused heterocyclenylheteroaryl, fused heterocyclylheteroaryl, and the like, as described herein, which are optionally substituted including to a solid support (or resin) directly or through a linker attached to the to the solid support.

“Aryl”, as used herein, means one or more aromatic rings, each of 5 or 6 ring carbon atoms and includes substituted aryl having one or more non-interfering substituents. Multiple aryl rings may be fused, as in naphthyl, or unfused, as in biphenyl.

“Cyclic”, as used herein, means a radical that is part of a ring systems which consist of 5, 6, or 7 atoms.

“Derived from”, as used herein, means any acceptable organic groups having a functional group such as carboxylic acid (COOH), isocyanide (NC), aldehyde (CHO) or ketone (CO). These functional groups react as skilled artisan would expect.

“Halo”, as used herein, means chloro, fluoro, iodo or bromo.

“Heteroaryl”, as used herein, means an aromatic monocyclic or multicyclic ring system of about 5 to about 14 carbon atoms, preferably about 5 to about 10 carbon atoms, in which one or more of the carbon atoms in the ring system is/are hetero element(s) other than carbon, for example nitrogen, oxygen or sulfur. Preferred ring sizes of rings of the ring system include about 5 to about 6 ring atoms. The “heteroaryl” may also be substituted by one or more “ring system substituents” which may be the same or different, and are as defined herein. The designation of the aza, oxa or thia as a prefix before heteroaryl define that at least a nitrogen, oxygen or sulfur atom is present respectively as a ring atom. A nitrogen atom of an heteroaryl may be a basic nitrogen atom and may also be optionally oxidized to the corresponding N oxide. Representative heteroaryl and substituted heteroaryl groups include pyrazinyl, furanyl, thienyl, pyridyl, pyrimidinyl, isoxazolyl, isothiazolyl, tetrazolyl, oxazolyl, thiazolyl, pyrazolyl, furazanyl, pyrrolyl, pyrazolyl, triazolyl, 1,2,4-thiadiazolyl, pyridazinyl, quinoxalinyl, phthalazinyl, imidazo[1,2-a]pyridine, imidazo[2,1-b]thiazolyl, benzofurazanyl, indolyl, azaindolyl, benzimidazolyl, benzothienyl, quinolinyl, imidazolyl, thienopyridyl, quinazolinyl, thienopyrimidyl, pyrrolopyridyl, imidazopyridyl, isoquinolinyl, benzoazaindole and 1,2,4-triazinyl.

“Heterocycle” or “heterocyclic radical”, as used herein, means one or more rings of 5, 6 or 7 atoms with or without unsaturation or aromatic character, optionally substituted, and at least one ring atom which is not carbon. Preferred heteroatoms include sulfur, oxygen, and nitrogen. Multiple rings may be fused, as in quinoline or benzofuran, or unfused as in 4-phenylpyridine.

A “library”, as used herein, means a collection of compounds created by a combinatorial chemical process, said compounds having a common scaffold with one or more variable substituents. The scaffold of the present invention is a Δ⁵-2-oxopiperazine.

A “library compound”, as used herein, means an individual reaction product, a single compound or a mixture of isomers, in a combinatorial library.

“Non-interfering substituents”, as used herein, mean those groups that do not significantly impede the process of the invention and yield stable Δ⁵-2-oxopiperazine library compounds.

“Organic moiety”, as used herein, means a substituent comprising a non-interfering substituent covalently bonded through at least one carbon atom. Suitable radicals for substitution onto the connecting carbon atom include, but are not limited to hydrogen, C₁-C₁₀ alkyl, C₂-C₁₀ alkenyl, C₂-C₁₀ alkynyl, C₁-C₁₀ alkoxy, C₇-C₁₂ aralkyl, C₇C₁₂ alkaryl, C₃-C₁₀ cycloalkyl, C₃-C₁₀ cycloalkenyl, C₂-C₁₂ alkoxyalkyl, aryl, heteroaryl, hydroxy (C₁-C₁₀) alkyl, halo(C₁-C₁₀) alkyl, aryloxy (C₁-C₁₀) alkyl, fluoroalkyl, nitro (C₁-C₁₀) alkyl, cyano (C₁-C₁₀) alkyl and heterocyclic radical. More examples and definition of these groups can be found in, for example, Jerry March, Advanced Organic Chemistry 4^{th}. Ed., John Wiley & Sons (1992).

“Parallel synthesis”, as used herein, means the method of conducting combinatorial chemical synthesis of libraries wherein the individual combinatorial library compounds are separately prepared and stored without prior and subsequent intentional mixing.

“Protected α-aminoaldehyde or α-aminoketone”, as used herein, means an α-aminoaldehyde or α-aminoketone in which the carbonyl group is protected with, typically an acetal (ketal) group. Examples of protecting group of a carbonyl functional group can be found in Green and Wuts, Protective Groups in Organic Synthesis, 2^{nd} Ed., John Wiley & Sons (1991).

“Protecting group”, as used herein, means an organic group that is used to temporarily mask a functional group in a molecule so as not to interfere with the reaction of other functional groups in the molecule. The protecting group can be removed afterward. See more detail in Green and Wuts, Protective Groups in Organic Synthesis, 2^{nd} Ed., John Wiley & Sons (1991).

“Reagent”, as used herein, means a reactant, any chemical compound used in the combinatorial synthesis to place substituents on the scaffold of a library.

“Resin”, as used herein, means a solid support as defined above which is chemically modified as is known in the art to incorporate a plurality of reactive groups, such as isocyanate compound, is covalently bound directly to the solid support or attached to the solid support by covalent bonds through a linking group. The solid support optionally bears a linking group, such as acid labile linkage, which can be directly bound or through the liking group thereof to a reaction component in the method according to the invention.

“Substituents”, as used herein, mean chemical radicals which are bonded to or incorporated onto the Δ⁵-2-oxopiperazine scaffold through the combinatorial synthesis process. The different functional groups account for the diversity of the molecules throughout the library and are selected to impart diversity of biological activity to the scaffold in the case of diverse libraries, and optimization of a particular biological activity in the case of directed libraries.

“Substituted alkyl”, as used herein, means alkyl having one or more non-interfering substituents.

“Substituted heterocycle” or “Substituted heterocyclic radical”, as used herein, means heterocycle having one or more non-interfering substituents. Suitable radicals for substitution on the heterocyclic ring structure include, but are not limited to halo, C₁-C₁₀ alkyl, C₂-C₁₀ alkenyl, C₂-C₁₀ alkynyl, C₁-C₁₀ alkoxy, C₇-C₁₂ aralkyl, C₇-C₁₂ alkaryl, C₁-C₁₀ alkylthio, arylthic, aryloxy, arylamino, C₃-C₁₀ cycloalkyl, C₃-C₁₀ cycloalkenyl, di(C₁-C₁₀)-alkylamino, C₂-C₁₂ alkoxyalkyl, C₁-C₆ alkylsulfinyl, C₁-C₁₀ alkylsulfonyl, arylsulfonyl, aryl, hydroxy, hydroxy (C₁-C₁₀) alkyl, aryloxy (C₁-C₁₀) alkyl, C₁-C₁₀ alkoxycarbonyl, aryloxycarbonyl, C₁-C₁₀ alkanoyloxy, aryloyloxy, substituted alkoxy, fluoroalkyl, nitro, cyano, cyano (C₁-C₁₀) alkyl, C₁-C₁₀ alkanamido, aryloylamido, arylaminosulfonyl, sulfonamido, heterocyclic radical and nitroalkyl. More examples and definition of these groups can be found in, for example, Jerry March, Advanced Organic Chemistry 4^{th}. Ed., John Wiley & Sons (1992).

“Solid-phase synthesis”, as used herein, means a heterogeneous reaction in which one of reactants is covalently connected to a solid support (polymer or resin, etc.). Other reactants are dissolved in an organic solvent or solvents and the product is obtained through a cleavage step from the solid support.

“Solid support”, as used herein, means a substrate which is inert to the reagents and reaction conditions described herein, as well as being substantially insoluble in the media used. Representative solid supports include inorganic substrates such as kieselguhr, silica gel, and controlled pore glass; organic polymers including polystyrene, polypropylene, polyethylene glycol, polyacrylamide, cellulose, and the like; and composite inorganic/polymeric compositions such as polyacrylamide supported within a matrix of kieselguhr particles. See J. M. Stewart and J. D. Young, Solid Phase Peptide Synthesis, 2^{nd}, Ed., Pierce Chemical Co. (Chicago, Ill., 1984). A polymer is preferably used in this invention. In addition, “solid support” includes a solid support as described above which is affixed to a second inert support such as the pins described herein which comprise a detachable polyethylene- or polyproylene-base head grafted with an amino functionalized methacrylate copolymer and an inert stem. In addition, “solid support” includes polymeric supports such as the polyethylene glycol supports described by Janda et al., Proc. Natl. Acad. Sci. USA, 92, 6419-6423 (1995) and S. Brenner, WO 95/16918, which are soluble in many solvents but can be precipitated by the addition of a precipitating solvent. The solid support is designated as [symbol] in this specification.

“Solution-phase synthesis”, as used herein, means a reaction in which all the reactants are dissolved in an organic solvent or solvents and the product is obtained following typical organic reaction work-up procedures.

“Solvent”, as herein used, means a liquid that can dissolve other compound and has no adverse effect on the reaction or on the reagents involved. Examples of suitable solvents include alcohols (methanol, 1-butanol, phenol, trifluoroethanol, hexafluoro-2-propanol, etc.), hydrocarbons (benzene, toluene, etc.), amides (dimethyl acetamide, dimethylformamide, etc.), halides (dichloromethane, dichloroethane, etc.), and ethers (tetrahydrofuran, dioxane, etc.). Other solvents include water, 1-methyl-2-pyrrolidine, diethyl phosphite, tetramethaylsulphone, dimethyl sulphoxide, acetonitrile and pyridine. Preferred solvents in the invention are alcohol-related solvents or halides or the mixture of alcohol with a halide solvent. More preferred is methanol and chloroform.

“Under acidic condition”, as used herein, means the reaction is conducted in the presence of an acid which itself is not part of the reactant. The acid can be either inorganic ones such as hydrochloric acid, sulfuric acid or organic acids such as trifluoroacetic acid, p-toluenesulfonic acid, camphor sulfonic acid. Preferred acid is hydrochloric acid for the solution phase reaction and trifluoroacetic acid for the solid phase synthesis.

“Work-up”, as used herein, means the procedure that separates a product in an organic reaction. Typically, the work-up procedure including an extraction of the reaction mixture with an organic solvent, washing of the extraction with appropriate inorganic acid or base such as hydrochloric acid or sodium bicarbonate, drying of the organic extraction over drying reagents such as magnesium sulfate or sodium sulfate, removal the organic solvent under reduced pressure and purification of the crude product on a silica gel plate or a silica gel column. For the solid-phase synthesis, the work-up procedure may simply include removal of solvents and reagents used to cleave the product from a solid support and purification of the product, if needed.

Chemistry

### SOLUTION-PHASE SYNTHESIS OF 4-N-ACYL-Δ⁵-2-OXOPIPERAZINES

In one aspect, the compounds of the invention represented by formula (I) wherein R₁, R₂, R₃, R₄, R₅, R₆ are hereinbefore defined, are synthesized according to Scheme 1. Thus, Ugi four component condensation of a carboxylic acid of formula (II) with a ketone or aldehyde compound of formula (III), a protected α-aminoaldehyde or α-aminoketone of formula (IV) and an isocyanide of formula (V) in a solvent furnished an intermediate (VI), which without isolation and upon treatment with an acid afforded the compound of formula (I).

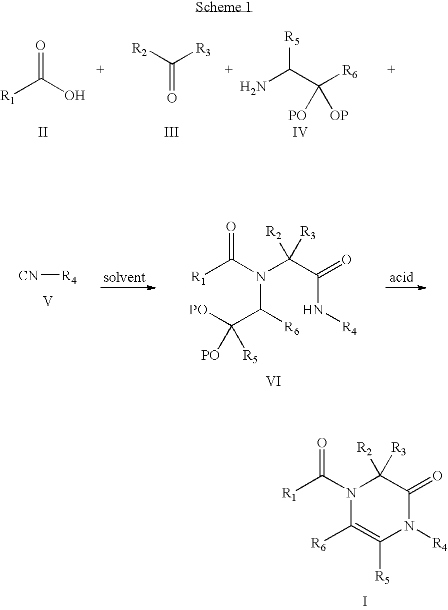

The reaction can be carried out in an organic solvent provided that the individual reactant is soluble in this solvent. Preferred solvent is alcohol-related or the mixture of an alcohol with a chlorinated solvent.

Both aliphatic and aromatic carboxylic acids can be used in these reactions. Similarly, there is no restriction on ketone (III), amino ketone (or aldehyde, IV) and isocyanide (V) that can be used in the above reaction.

The acid that can be used to facilitate the cyclization to provide the desired product includes inorganic acids such as HCl, H₂SO₄ or certain organic acids such as trifluoroacetic acid.

### SOLID-PHASE SYNTHESIS OF 4-N-ACYL-Δ⁵-2-OXOPIPERAZINES

In another aspect, a solid-phase synthesis of a combinatorial library of the compounds of the invention can be carried out according to Scheme 2 to Scheme 5. Briefly, any one of four components used in Scheme 1 is linked to a solid support via an acid-liable linkage before it is used to react with other reactants. The intermediates formed in the solid phase synthesis (e.g. VIII) are still linked to the solid support via an acid-liable linkage. The Δ⁵-2-oxopiperazine product (I) is obtained free of solid support through an acidic cleavage procedure. The acid also facilitates the ring formation reaction as seen in the solution phase reaction (Scheme 1). The combinatorial library of Δ⁵-2-oxopiperazine compounds are prepared in parallel synthesis in a 96 well microtiter plate with a fritz on the bottom so that the solvent can be drained out after the reaction.

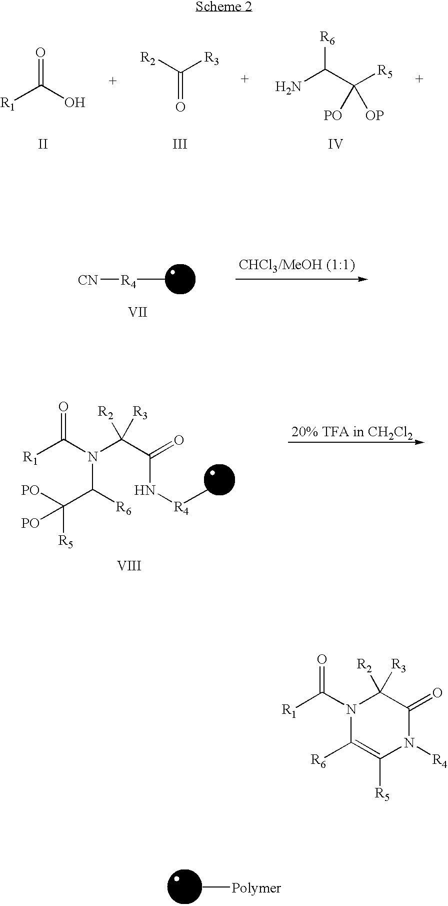

The polymer bound isocyanide (VII) shown in Scheme 2 is used to react with a carboxylic acid of formula (II), a ketone or aldehyde of formula (III) and a protected α-aminoketone or α-aminoaldehyde of the formula (IV) in a solvent to afford the polymer bound intermediate (VIII), which upon acid treatment gives rise to Δ⁵-2-oxopiperazine compound of formula (I) in good yield and purity.

There is no specific restriction on polymer-bound isocyanide used in these reactions, provided that the linkage between cyanide functional group and the polymer can be cleaved under acidic conditions such as TFA. Examples include those shown in structure VII-A to VII-C, which utilize an ester, an amide, or an ether link between cyanide functional group and the solid support.

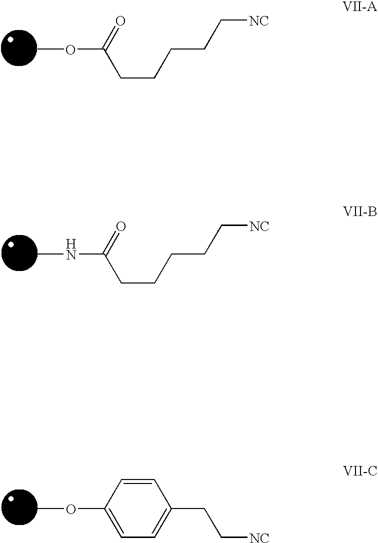

The solid phase reaction shown in Scheme 2 is conducted in a mixed solvent system, preferably a mixture of an alcoholic solvent with a chlorinated solvent such as methanol and chloroform. The reaction is performed generally at room temperature. The preferred acid for the cleavage is TFA.

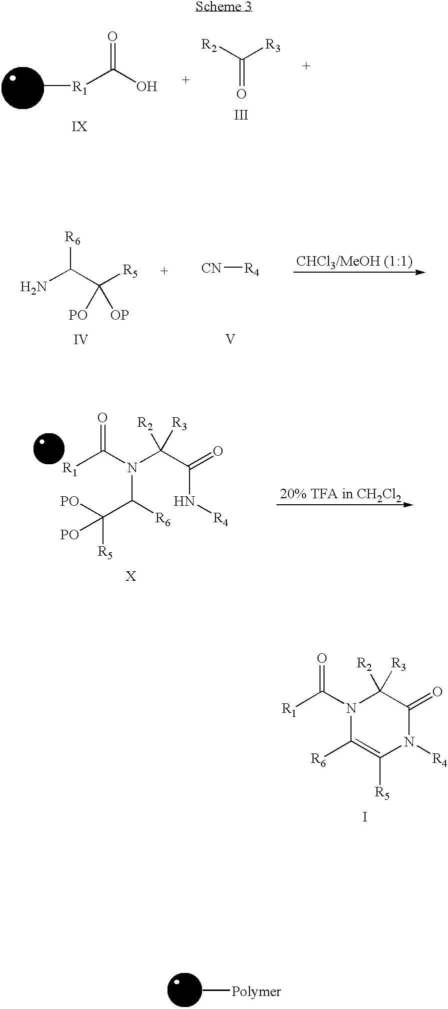

In Scheme 3, the reactants are the same as those shown in Scheme I except the carboxylic acid is now linked to a polymer. Accordingly, the linkage that connects the carboxylic acid functional group with the polymer can be again an ester, an amide or an ether or any other acid-labile groups.

The solid phase reaction shown in Scheme 3 is conducted in a mixed solvent system, preferably a mixture of an alcoholic solvent with a chlorinated solvent such as methanol and chloroform. The reaction is performed generally at room temperature. The preferred acid for the cleavage is TFA.

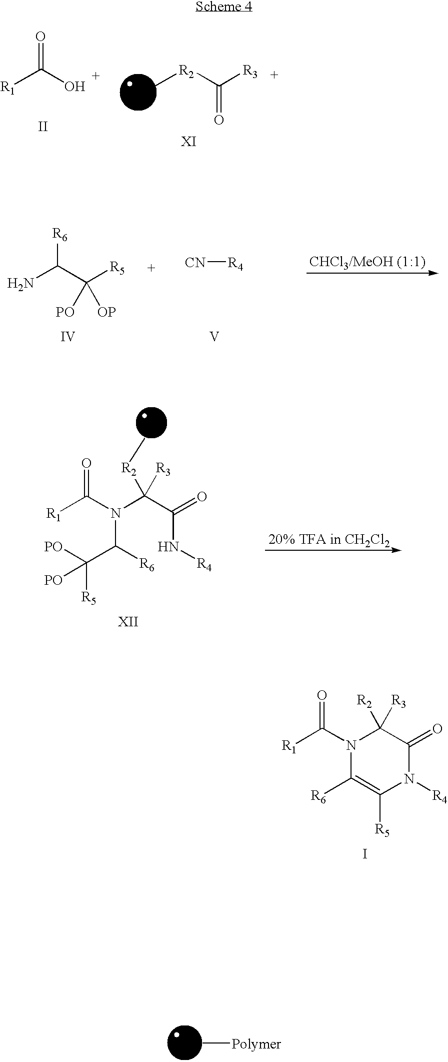

Polymer bound ketones or aldehydes (XI) is also used in the solid phase reaction to prepare Δ⁵-2-oxopiperazine compound as shown in Scheme 4. The reaction is conducted in a mixed solvent system, preferably a mixture of an alcoholic solvent with a chlorinated solvent such as methanol and chloroform. The reaction is performed generally at room temperature. The preferred acid for the cleavage is TFA.

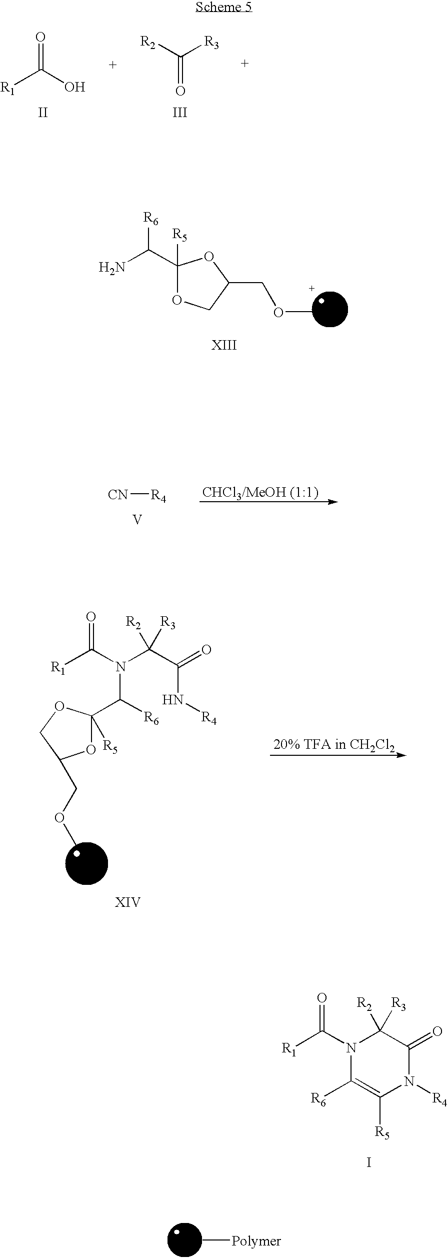

Although immobilization of an amino functional group can be achieved easily, the amino acetal resin such as XIII has not been described previously. This novel resin bound α-aminoacetal (XIII) is prepared through an acetal exchange of the α-aminoacetaldehyde or α-aminoketone diethyl acetal (XIII-A) with glycerol resin (XIII-B) in the presence of an acid such as p-toluenesulfonic acid, camphor sulfonic acid or hydrochloric acid at room temperature (Scheme 6). The resulting amino acetal resin is then used in the four-component Ugi reaction under the same condition described above. Cleavage of the resin-bound intermediate with TFA provides the desired product (Scheme 5).

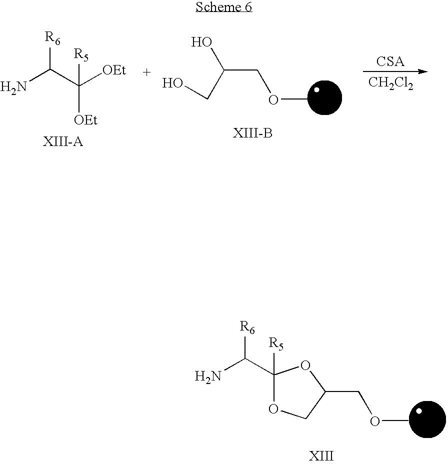

### EXAMPLES

To further illustrate this invention, the following examples are included. The examples should not, of course, be construed as specifically limiting the invention. Variations of these examples within the scope of the claims are within the purview of one skilled in the art are considered to fall within the scope of the invention as described, and claimed herein. The reader will recognize that the skilled artisan, armed with the present disclosure, and skill in the art is able to prepare and use the invention without exhaustive examples.

Trademarks used herein are examples only and reflect illustrative materials used at the time of the invention. The skilled artisan will recognize that variations in lot, manufacturing processes, and the like, are expected. Hence the examples, and the trademarks used in them are non-limiting, and they are not intended to be limiting, but are merely an illustration of how a skilled artisan may choose to perform one or more of the embodiments of the invention.

¹H nuclear magnetic resonance spectra (NMR) is measured in CDCl₃ or other solvents as indicated by a Varian NMR spectrometer (Unity Plus 400, 400 MHz for ¹H) unless otherwise indicated and peak positions are expressed in parts per million (ppm) downfield from tetramethylsilane. The peak shapes are denoted as follows, s, singlet; d, doublet; t, triplet; m, multiplet.

The following abbreviations have the indicated meanings:
Ac=acetyl
Bn=benzyl
CDCl₃=deutered chloroform
CD₃CN=deutered acetonitrile
CH₂Cl₂=dichloromethane
Cpd=compound
DMAP=4-(dimethylamino)pyridine
DMF=N,N-dimethylformamide
DMSO=dimethylsulfoxide
ESIMS electron spray mass spectrometry
Et₃N=triethylamine
EtOAc=ethyl acetate
HCl=hydrochloric acid
HF=hydrofluoric acid
MgSO₄=magnesium sulfate
Ph=phenyl
Py=pyridinyl
TFA=trifluoroacetic acid
THF=tetrahydrofuran
TLC=thin layer chromatography

The following alkyl group abbreviations are used.
Me=methyl
Et=ethyl
n-Pr=normal propyl
i-Pr=isopropyl
n-Bu=normal butyl
i-Bu=isobutyl
t-Bu=tertiary butyl
s-Bu=seconday butyl
c-Hexyl=cyclohexyl

### Example 1

### Preparation of (4-benzoyl-3-isopropyl-2-oxo-3,4-dihydropyrazin-1(2H)yl)acetic Acid, Methyl Ester

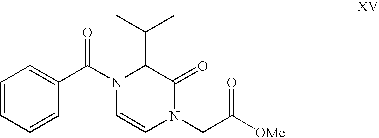

Benzoic acid (610.6 mg 5 mmol), isobutyraldehye (454 μL, 5 mmol), aminoacetaldehyde diethyl acetal (727 μL, 5 mmol) and isocyanatoacetate (454.5 μL, 5 mmol) were mixed in a round bottom flask in CH₂Cl₂ (5 mL) and MeOH (5 mL) at room temperature. After stirring for 48 hours, the reaction mixture was treated with 5 mL of 1N HCl for 2 hours followed by 50% TFA in CH₂Cl₂ for 4 hours. The organic solvents were removed under reduced pressure and the residue was extracted with EtOAc three times. The combined organic extracts were washed with brine and dried over MgSO₄. Purification of the residue with a silica gel column (Acetonitrile: CH₂Cl₂, 3:97) afforded the title compound in 75.3% yield (1.19 g). ¹HNMR δ0.95 (d, 3H), 1.12 (d, 3H), 2.13 (m, 1H), 3.72 (s, 3H), 4.25 (dd, 2H), 4.95 (d, 1H), 5.50 (d, 1H), 5.92 (d, 1H), 7.30-7.50 (m, 5H); ESIMS: m/z 317 (M+H).

| Cpd | R₁ | R₂ | R₃ | R₄ | R₅ | R₆ | Mass S [symbol] |
|---|---|---|---|---|---|---|---|
| XVI | Ph | i-Pr | H | nBu | H | H | 331(M [symbol] |
| XVII | 4-MeOPh | i-Pr | H | 2,6-diphenyl | H | H | 349(M [symbol] |
| XVIII | Ph | Ph | H | MeO₂CCH₂ | H | H | 351(M [symbol] |

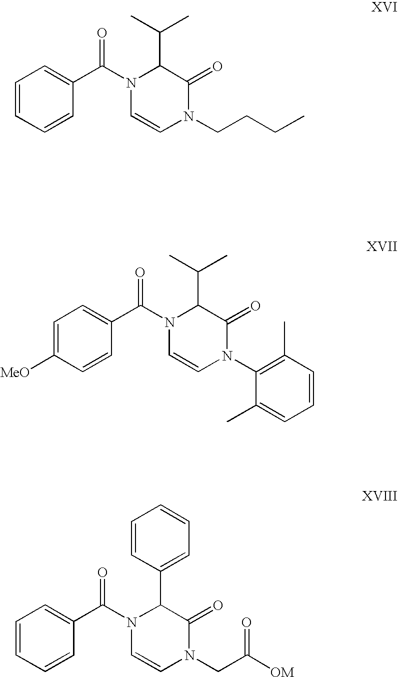

### Example 2

### Preparation of 4-(4-methoxycarbonylbenzoylyl-[2-(4-hydroxyphenyl)ethyl]-3-isopropyl-3,4-dihydro-pyrazin-2(1H)-one

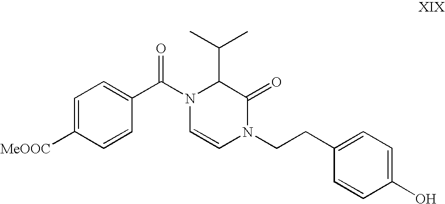 Step 1
Preparation of Polymer Bound Isocyanide (VII-C)

Cesium carbonate (24.7 g, 84 mmol) was added to the suspension of brominated Wang resin (1.4 mmol/g, 20 g) and N-(p-hydroxylphenylethyl)formamide (13.86 g, 84 mmol) in DMF (150 mL) at room temperature under nitrogen atmosphere. The reaction mixture was stirred at the temperature for 14 hours. The resin was filtered and washed with DMF, methanol, dichloromethane repeatedly and dried up under vacuum to give the resin bound formamide (21.87 g). Part of the resin (182.7 mg) was treated with 20% TFA to give 32.2 mg starting N-(p-hydroxylphenylethyl)formamide. The loading of the resin is therefore determined to be 1.07 mmol/g.

To the suspension of formamide resin (12 g, 14.4 mmol) obtained above in dichloromethane (50 mL) was added triethylamine (6.0 mL, 43.2 mmol) followed by triphenylphosphine (11.3 g, 43.2 mmol) and carbon tetrachloride (4.2 ml, 43.2 mmol). The reaction mixture was stirred under nitrogen atmosphere at room temperature for 16 hours. The solvent was drained and the resin was washed with DMF, methanol and dichloromethane repeatedly and dried under vacuum to give the desired isocyanide resin (11 g).

Step 2

To the suspension of the isocyanide resin (150 mg, 0.946 mmol/g) in the mixture of methanol (1.5 mL) and chloroform (1.5 mL) in a glass filter tube were added aminoacetaldehyde diethyl acetal (82.7 μl, 0.6 mmol), isobutyraldehyde (54.5 μL, 0.6 mmol) at room temperature. The reaction mixture was shaken for 30 minutes before monomethyl teraphthalate (108.1 mg, 0.6 mmol) was added. The mixture was then shaken for 48 hours. The solvents were drained and the resin was washed with DMF, methanol and dicholormethane repeatedly and dried under vacuum. The resin was treated with 20% TFA for 20 minutes twice and the organic solvent was evaporated under reduced pressure. Purification of the residue with preparative TLC (Acetonitrile: CH₂Cl₂, 10:90) afforded the desired product (56.1 mg, 95.4%). ¹H NMR (CD₃CN) 81.02 (6H, t), 2.04 (m, 1H), 2.90 (m, 2H), 3.80 (m, 2H), 4.00 (s, 3H), 4.81 (d, 1H), 5.62 (d, 1H), 5.82 (d, 1H), 6.82 (d, 2H), 7.18 (d, 2H), 7.20 (brs, 1H), 7.60 (d, 2H), 8.16 (d, 2H); ESIMS: m/z 423 (M+H).

| Cpd | R₁ | R₂ | R₃ | R₄ | R₅ | R₆ | Mass Sp [symbol] |
|---|---|---|---|---|---|---|---|
| XX | m-NO₂Ph | i-Pr | H | 4-HOPhCH₂CH₂ | H | H | 410(M + [symbol] |
| XXI | p-F-Benzyl | i-Pr | H | 4-HOPhCH₂CH₂ | H | H | 397(M + [symbol] |
| XXII | 4-MeO₂CPh | 4-MeOPh | H | 4-HOPhCH₂CH₂ | H | H | 487(M + [symbol] |
| XXIII | 4-MeO₂CPh | c-Hexyl | H | 4-HOPhCH₂CH₂ | H | H | 463(M + [symbol] |

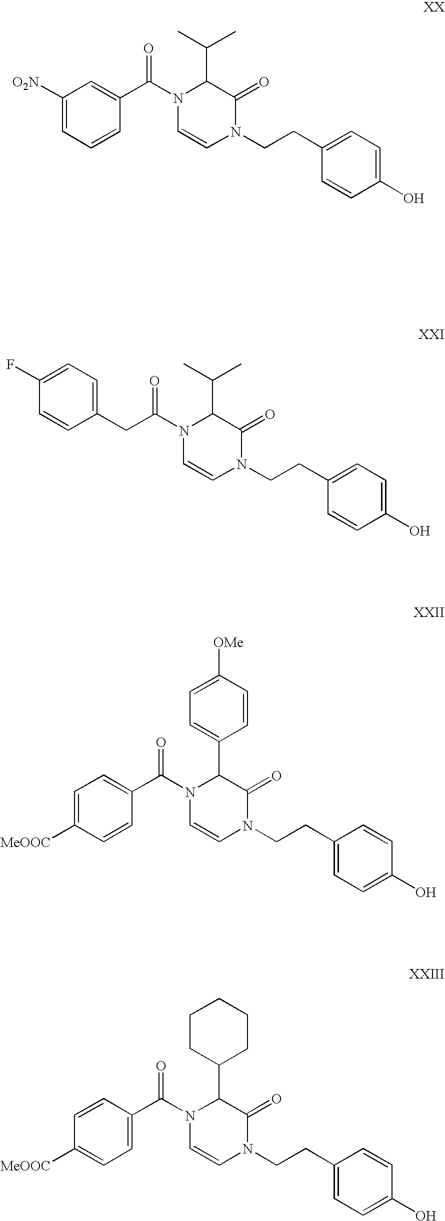

### Example 3

### Preparation of 6-(4-phenylpropanoyl-3-isopropyl-2-oxo-3,4-dihydropyrazin-1(2H)-yl) Hexanoic Acid

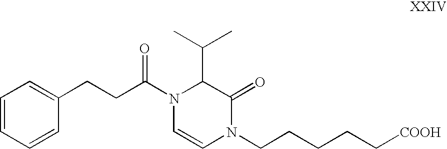 Step 1
Preparation of Polymer Bound Isocyanide (VII-A)

To the suspension of Wang resin (20 g, 1.6 mmol/g) and N-formyl-6-aminocarporic acid (15.26 g, 96 mmol) in THF (250 mL) were added diisopropyl carbodiimide (15 mL, 96 mmol) followed by dimethylaminopyridine (11.7 g, 96 mmol) at room temperature. The reaction mixture was gently stirred under nitrogen atmosphere for 72 hours. The resin was filtered out and washed with DMF, methanol and dichloromethane repeatedly and dried under vacuum (27.5 g).

To the suspension of the formamide resin (5 g) obtained above in dichloromethane was added triethylamine (2.1 mL, 15 mmol) followed by triphenylphosphine (3.93 g, 15 mmol) and carbon tetrachloride (1.5 ml, 15 mmol). The reaction mixture was stirred under nitrogen atmosphere at room temperature for 16 hours. The solvent was drained and the resin was washed with DMF, methanol and dichloromethane repeatedly and dried under vacuum to give the desired isocyanide resin VII-C (4.9 g).

Step 2

To the suspension of the isocyanide resin VII-C (150 mg) in the mixture of methanol (1.5 mL) and chloroform (1.5 mL) in a glass filter tube were added aminoacetaldehyde diethyl acetal (109 μl), isobutyraldehyde (68 μL) at room temperature. The reaction mixture was shaken for 30 minutes before hydrocinnamic acid (135 mg) was added. The mixture was then shaken for 48 hours. The solvents were drained and the resin was washed with DMF, methanol and dicholormethane repeatedly and dried under vacuum. The resin was treated with 20% TFA for 20 minutes twice and the organic solvent was evaporated under reduced pressure. Purification of the residue with preparative TLC (Acetonitrile: CH₂Cl₂, 10:90) afforded the product (XXIV, 37.3 mg). ¹HNMR δ 0.92 (t, 3H), 0.99 (t, 3H), 1.38 (m, 2H), 1.62 (m, 4H), 1.98 (m, 1H), 2.38 (t, 2H), 2.70 (t, 2H), 3.00 (m, 2H), 3.48 (m, 2H), 4.90 (d, 1H), 5.58 (d, 1H), 6.02 (d, 1H), 7.22 (m 2H), 7.30 (m, 3H); ESIMS: m/z 387 (M+H).

| Cpd | R₁ | R₂ | R₃ | R₄ | R₅ | R₆ | Mass Spec |
|---|---|---|---|---|---|---|---|
| XX | Ph | i-Pr | H | HOOC(CH₂)₄CH₂ | H | H | 359(M + H) |
| XXI | 1,3- | i-Pr | H | HOOC(CH₂)₄CH₂ | H | H | 403(M + H) |
| | benzodioxol-5- | | | | | | |
| | yl | | | | | | |
| XXII | 4-MeO₂CPh | 4-MeOPh | H | HOOC(CH₂)₄CH₂ | H | H | 481(M + H) |
| XXIII | c-Hexyl | i-Pr | H | HOOC(CH₂)₄CH₂ | H | H | 365(M + H) |

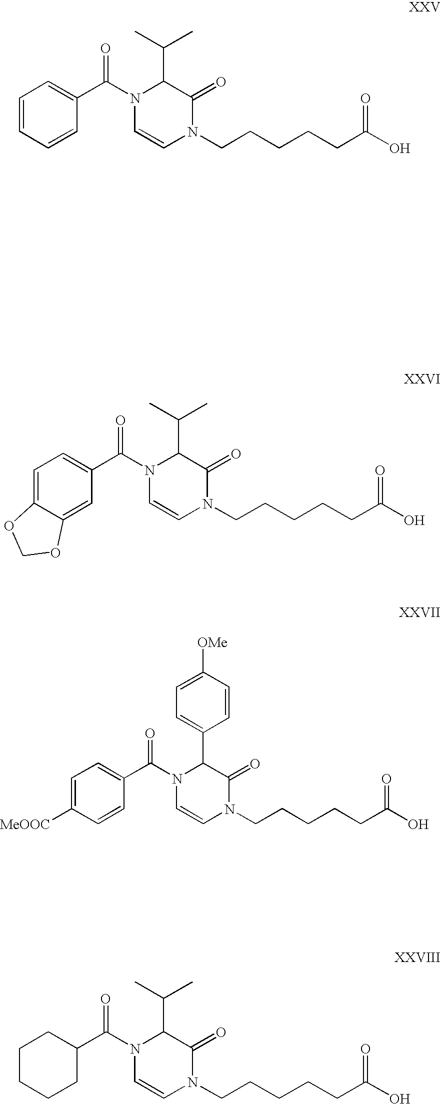

The following compounds are considered to be part of the invention.

| Cpd | R₁ | R₂ | R₃ | R₄ | R₅ | R₆ |
|---|---|---|---|---|---|---|
| XXIX | Ph | i-Pr | Me | HOOC(CH₂)₄CH₂ | Me | Me |
| XXX | 1,3- | i-Pr | H | HOOC(CH₂)₄CH₂ | Ph | H |
| | benzodioxol- | | | | | |
| | 5-yl | | | | | |
| XXXI | 4-MeO₂CPh | 4-MeOPh | H | HOOC(CH₂)₄CH₂ | H | Ph |
| XXXII | c-Hexyl | i-Pr | Me | HOOC(CH₂)₄CH₂ | Et | H |

1. A process for preparing a Δ⁵-2-oxopiperazine compound of the formula 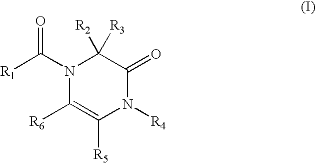
comprising the steps of:
(i) reacting the following four compounds:
a carboxylic acid compound of formula
R₁COOH,
a ketone or aldehyde compound of formula
R₂COR₃,
an isocyanide compound of formula
R₄NC, and
a protected α-aminoaldehyde or α-aminoketone compound of formula R₅CH(NH₂)C(OP)₂R₆, wherein P is a protecting group of the carbonyl group, in a solvent to produce an intermediate compound of the formula (VI) 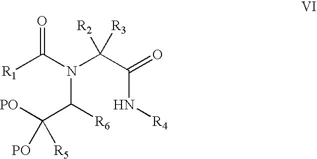
, and
ii) reacting the intermediate compound under acidic condition to provide the Δ⁵-2-oxopiperazine compound,
wherein R₁ is a substituent derived from a carboxylic acid of formula R₁COOH,
R₂ and R₃ represent hydrogen, or an organic moiety derived from a ketone or an aldehyde of the formula R₂COR₃,
R₄ is an organic moiety derived from an isocyanide of formula R₄NC which in turn is derived from a primary amine of the formula R₄NH₂,
R₅ and R₆ are organic moieties derived from a protected α-aminoaldehyde or α-aminoketone of the formula R₅CH(NH₂)C(OP)₂R₆, wherein P is a protecting group of the carbonyl group.

2. A process of claim 1, wherein one of said four compounds is bounded to a polymer and the reacting steps are performed in the solid phase.

3. A process of claim 1, wherein said isocyanide compound of formula R₄NC is bound to a polymer and the reacting steps are performed in the solid phase.

4. A process of claims 1 to 3, wherein said acid is trifluoroacetic acid (TFA).

5. A process of claim 1, wherein said reacting steps are performed in the solution phase.

6. A process of claim 1, wherein R₁ represents aromatic, aliphatic, heterocyclic, or heteroaryl groups.

7. A process of claim 1, wherein R₂ represents aliphatic, aromatic, heterocyclic, or heteroaryl groups.

8. A process of claim 1, wherein R₄ represents aliphatic, aromatic, heterocyclic, or heteroaryl groups.

9. A compound of formula (I) 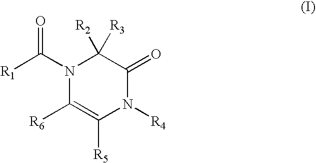
wherein R₁ is a substituent derived from a carboxylic acid of formula RICOOH,
R₂ and R₃ represent hydrogen, or an organic moiety derived from a ketone or an aldehyde of the formula R₂COR₃,
R₄ is an organic moiety derived from an isocyanide of formula R₄NC which in turn is derived from a primary amine of the formula R₄NH₂,
R₅ and R₆ are organic moieties derived from a protected α-aminoaldehyde or α-amino ketone of the formula R₅CH(NH₂)C(OP)₂R₆, wherein P is a protecting group of the carbonyl group.

10. The compound of claim 9, wherein R₁ represents aromatic, aliphatic, heterocyclic, or heteroaryl groups.

11. The compound of claim 9, wherein R₂ represents aliphatic, aromatic, heterocyclic, or heteroaryl groups.

12. The compound of claim 9, wherein R₄ represents aliphatic, aromatic, heterocyclic, or heteroaryl groups.

13. A combinatorial library of 2-oxopiperazine compounds wherein said library contains a plurality of diverse library compounds of the formula 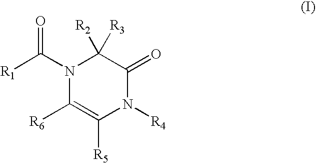
wherein R₁ is a substituent derived from a carboxylic acid of formula R₁COOH,
R₂ and R₃ represent hydrogen, or an organic moiety derived from a ketone or an aldehyde of the formula R₂COR₃,
R₄ is an organic moiety derived from an isocyanide of formula R₄NC which in turn is derived from a primary amine of the formula R₄NH₂,
R₅ and R₆ are organic moieties derived from a protected α-aminoaldehyde or α-amino ketone of the formula R₅CH(NH₂)C(OP)₂R₆, wherein P is a protecting group of the carbonyl group.

14. The combinatorial library of claim 13, wherein R₁ represents aromatic, aliphatic, heterocyclic, or heteroaryl groups.

15. The combinatorial library of claim 13, wherein R₂ represents aliphatic, aromatic, heterocyclic, or heteroaryl groups.

16. The combinatorial library of claim 13, wherein R₄ represents aliphatic, aromatic, heterocyclic, or heteroaryl groups.
